(19) United States
(12) Patent Application Publication
(10) Pub. No.: US 2023/0162011 A1
(43) Pub. Date: May 25, 2023

(54) CONFIGURATION OF CUE INTEGRATION SYSTEM

(71) Applicant: Wenyue DAI, Zhuhai (CN)

(72) Inventor: Wenyue DAI, Zhuhai (CN)

(21) Appl. No.: 17/603,805

(22) PCT Filed: Apr. 20, 2020
(86) PCT No.: PCT/CN2020/085717

§ 371 Date: Mar. 16, 2022

(30) Foreign Application Priority Data
Apr. 24, 2019 (CN) 201910335216.6

(51) Int. Cl. G06N 3/063

(52) U.S. Cl. CPC G06N 3/063

(57) ABSTRACT

A basic configuration of clue integration system, aiming to provide a basic structure and a basic operation method for a multi-category clue integration system capable of maintaining activation relationships between clues, and having a unified structural form and operation mechanism. To achieve the aim, the invention uses cognitive clues as a basis to propose a series of technical structures such as invalid clues, valid clues, source clues, target clues, clue-unit, source-target relationships and clue-unit network, also to propose basic operation methods such as measurement and control rules of a clue-unit and a clue detection driving mechanism, thereby enabling related clues in different categories to integrate and collaborate. The invention can provide a basic construction method and a basic system for brain-like intelligent systems.

### TECHNICAL FIELD

The present invention relates to the field of brain-like artificial intelligence, specifically, to the clue integration system.

### BACKGROUND

The brain cognitive system is an extremely complex multi-category information integration and collaboration system, including perception, attention, understanding, memory and control. Each category provides certain information for cognitive activities, and the integration and collaboration of the information from different categories forms the important foundation of the cognitive activities of the brain.

Brain-like intelligence is a crucial part of artificial intelligence, which aims to equip robots with the cognitive ability like humans. Existing research of brain-like intelligence mainly focuses on various types of algorithm, such as artificial neural networks, machine learning etc., which relies on the strong capacity of calculation rather than a multi-category information integration and collaboration system.

Despite the wide recognition of the impact of context, common senses, perception, attention, memory, thinking, regulation and control on cognitive activities, information that benefits cognition activities can hardly be used in time due to the lack of a multi-category information integration method and system that has unified structural form and operation mechanism in the field of brain-like artificial intelligence.

### SUMMARY

### Technical Problem

The technical problem to be solved by the present invention is: to provide a basic configuration of a multi-category clue integration system, which is capable of maintaining an activation relationship between clues, and possessing the unified structural form and operation mechanism, that is, a basic structure and a basic operation mechanism of the clue integration system.

### Technical Solutions

In order to solve the above technical problem, the present invention starts with clues, proposes a series of technical structures such as invalid clues, valid clues, source clues, target clues, clue-unit, source-target relationship, and clue-unit network, as well as the basic operation methods such as measurement and control rules of a clue-unit, a clue detection driving mechanism and so on. These technical structures and operation methods enable the integration and collaboration of information from different categories thereby forming the basic structure and the basic operation mechanism of the clue integration system. The contents of the two aspects of the present invention are described in detail below.

1. The Basic Structure of the Clue Integration System

The “clue-unit network” of the present invention is the basic structure of the clue integration system. The clue-unit network is composed of the clue-units connected according to the source-target relationship between the clues, and the constituents thereof include: clue, clue-unit, source-target relationship, which are described in detail below.

1.1 “clue”, in the present invention, refers to information that has a guiding effect in cognition of things. The carrier of a clue is a clue-unit. A clue has a one-to-one correspondence relationship with a clue-unit, and the clue-unit is also called clue for short as when it is not confusing.

There are activation effects between related clues. The clue that sends the activation effect is called source clue, and the clue that is subject to the activation effect is called target clue. A source clue loads the activation effect to its target clue according to a set output.

The most common case is that one clue can be subject to the activation effect in some time, and can also send its activation effect in some time. That is, one clue has both its source clues and its target clues.

In the present invention, a clue activated into valid is called “valid clue”, an inactivated clue is called “invalid clue”. The activation state of a clue is either valid or invalid, and they are all called as clues when it is not confusing.

Whether an invalid clue can be activated into a valid clue depends on whether its activation condition is met. Therefore, each clue must have its set activation condition.

In the present invention, a clue is the core element of a clue-unit. Each clue (a clue is often called as the present clue relative to the clue-unit it belongs to.) belongs to a clue-unit and has a one-to-one correspondence relationship with the clue-unit.

1.2 “Clue-unit”, proposed by the present invention, is the carrier of a clue, and also a basic element constituting the clue-unit network.

FIG. 1 illustrates the configuration of a clue-unit, it shows that there are p source clue-units and q target clue-units that are directly connected to the clue-unit.

The vertical line and arrows on the left side of FIG. 1 represent the input unit of the clue-unit, which receives input from each of the source clues. The vertical line and arrows on the right side of FIG. 1 represent the output unit of the clue-unit, which is used to output the activation effect of the present clue to each of its target clues. The clue-unit body in the double dot line box of FIG. 1 represents the present clue, and comprises an activation effect synthesis unit and a measurement and control unit.

The clue-unit in the present invention has: a clue and its set activation condition; an activation effect input unit, used to receive activation effect of each source clue; an activation effect synthesis unit, used to synthesize the activation effect from each source clue into a synthesized activation effect to be loaded to the present clue; an activation effect output unit, used to output the activation effect of the present clue according to the source-target relationships; and a measurement and control unit, used to coordinate and control each component of the clue-unit according to the activation condition of the present clue.

The input unit is usually embodied as an input interface; the synthesis unit is usually embodied as a synthesis rule; the output unit is usually embodied as several set outputs corresponding to the source-target relationships.

The measurement and control unit of a clue-unit runs autonomously according to measurement and control rules of a clue-unit. The measurement and control rules of a clue-unit is that the sufficient and necessary condition for the present clue to be activated and maintained into valid clue is that the synthesized activation effect to be loaded to the present clue is accord with the present clue's activation condition; if the present clue's activation condition is not met, the present clue remains invalid; if the present clue's activation condition is met, the present clue becomes valid clue immediately, and the activation effect output unit of the clue-unit is turned on, the set output is loaded to all target clues of the present clue according to the source-target relationships; and when the activation condition is no longer met, a set delay is triggered immediately, when the delay ends the present clue returns invalid and the activation effect output unit is turned off.

The meaning of setting delay is that when the activation effect of the source clues no longer meets the activation condition of the present clue, the valid clue does not return invalid clue immediately, thereby controllably extending the effective time of the present clue's set output.

When a clue is activated into a valid clue, the corresponding clue-unit also becomes a valid clue-unit; when the clue returns to be an invalid clue, the corresponding clue-unit returns to be an invalid clue-unit too.

1.3 “Source-target relationship”, in the present invention, refers to the activation effect relationship between two clues. Each pair of the source clue and target clue has a source-target relationship. Each source-target relationship has a set output. The source clue will load the activation effect to each of its target clues according to the set output when the source clue is activated into valid clue. The source clue's activation effect to be loaded to its target clues is sent from the activation output unit of the source clue-unit, and received by the activation effect input unit of the corresponding target clue-unit.

Primarily, the source-target relationship is a structural relationship, which clearly expresses the sender and receiver of the activation effect in a unified form, and expresses as well the activation effect from the source clue to the target clue by the set output. The clue-unit network is exactly composed of the clue-units connected according to the source-target relationships, and thereby forming the basic structure of the clue integration system.

The source-target relationship is also a logical relationship. It can be found out that the full activation process for a clue that is activated into a valid clue according to the source-target relationships. The clue activated into valid means that this clue is detected, while the full activation process of the clue is exactly what needs to be experienced in order to detect this clue.

2. The Basic Operation Mechanism of the Clue Integration System

The “clue detection driving mechanism” is the basic operation mechanism of the clue integration system in the present invention. This basic operation mechanism consists of two parts: (1) the measurement and control unit of every clue-unit runs autonomously according to the measurement and control rules of clue-unit; (2) all clue-units of the clue-unit network run in parallel according to the source-target relationships.

The reason why it is called the “clue detection driving mechanism” is that detecting the present clue of every clue-unit is the most primary power driving the operation of the clue integration system.

Detection of the present clue is automatically completed by the collaboration of the input unit, the synthesis unit, the measurement and control unit of the clue-unit. The collaboration of the three units constitutes a “present clue detector”. The connotation of the present clue detector is exactly the logic and evidence of the validity of the present clue.

The detection process of the present clue is an established activation process. If the activation effect from the source clues meets the activation condition of the present clue, the present clue is activated into a valid clue, otherwise, the present clue remains invalid.

When an invalid clue is activated into a valid clue, the activation effect of the clue is loaded to all of its target clues according to the source-target relationships. Among these target clues, if the activation condition of a certain target clue is met, the target clue is activated into a valid clue, otherwise, the clue remains invalid. This is the conduction principle of clue detection driving.

### BENEFICIAL EFFECT OF THE INVENTION

The basic structure and basic operation mechanism of the clue integration system of the present invention can maintain the activation effect relationships between clues, have unified structural form and operation mechanism, and allow clues of different categories to integrate and collaborate. The present invention is more similar to the brain cognitive system regarding basic structure and the working principle compared with various existing technical solutions based on computing methods and computing capability. The present invention can work as a basic construction method and a basic system of the brain-like intelligent system.

### BRIEF DESCRIPTION OF DRAWINGS

FIG. 1 is the configuration schematic diagram of a “clue-unit”.

FIG. 2 is a schematic diagram of the configuration of the subsystems of a general clue integration system.

FIG. 3 is a schematic diagram of the preliminary integration of the “Standing Posture” clue.

FIG. 4 is a schematic diagram of the position of each point in the “(0) Pixel Point Pattern” clue.

FIG. 5 is the design schematic diagram of “Pixel Point Brightness Change” clue-unit.

FIG. 6 is the design schematic diagram of the “Orientation Perceptual Benchmark Positioning Angle” clue-unit.

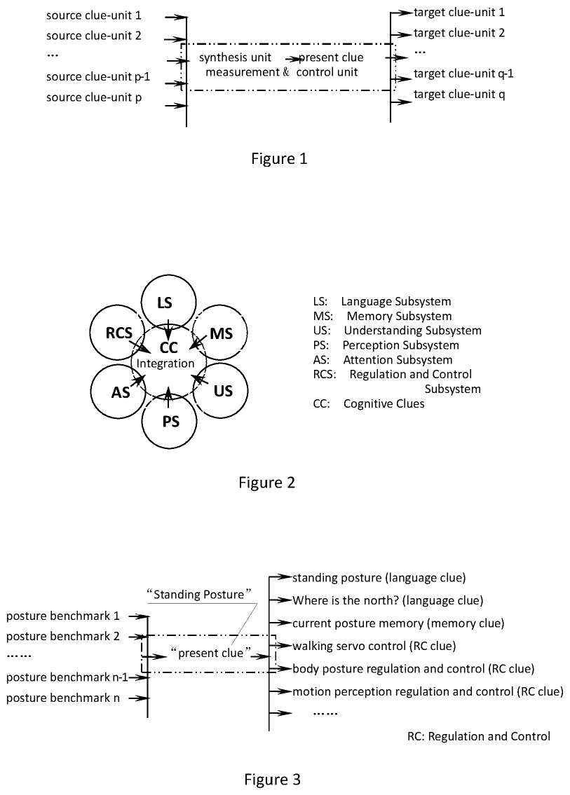

### OPTIMAL IMPLEMENTATION METHOD OF THE PRESENT INVENTION

The optimal embodiment of the present invention is as follows: (1) the subsystems are reasonably configured according to a specific application goal of the clue integration system, and clues are filtered and collected; (2) the clue-unit design is carried out; (3) the designed system is subjected to simulation analysis and optimization design; (4) a practical system is constructed by adopting computers or applicable chips. Among them, the technical solutions of (3) and (4) do not belong to the present invention.

### Optimal Implementation Embodiment of the Present Invention

The innovation of the present invention focuses on the integration of cognitive clues. The difficulties of the implementation mainly include configuration of the subsystem of the clue integration system, filtration and collection of clues, design of the clue-units, etc. Followed are the detailed descriptions with references to the embodiments.

### Embodiment 1: The Configuration of the Subsystems of the General Clue Integration System

If the goals of constructing the clue integration systems are different, the configurations of their subsystems may be different. To construct a general cognition system of things, the configuration of its subsystems should focus on the application of universal cognition principles.

FIG. 2 is a schematic diagram of the configuration of the subsystems of the general clue integration system. Perception, attention, understanding, memory, language, regulation and control, in the figure are all subsystems of the clue integration system. The centripetal arrows indicate that these subsystems are highly collaborating, and they provide their own cognitive clues to the cognition of the same thing.

The “cognitive clues integration” in the center of the diagram indicates that the clues provided by these subsystems are highly integrated. In the present invention, the so-called “clue integration” is to collect clues under the condition of “maintaining the source-target relationship between clues and following a unified structural form and operating mechanism”.

Followed is a brief description of each subsystem of the general clue integration system.

(1) The perception subsystem provides the most basic and core component clues in the clue integration system. Robots can rely on a variety of sensors to obtain perceptual clues like self, space, time, image, motion, sound, external force, etc., and integrate them into the perceptual clues. This ability of robots is quite different from that of humans.

To avoid making too many subsystems, in this embodiment, the sensory clues are classified into the perception subsystem. Therefore, the clues directly coming from sensors belong to the perception subsystem. Generally speaking, perception is the primary synthesis of sense, while deep-level synthesis, which belongs to the understanding subsystem, has multi-level source-target relationships.

The robot's self-perceptual clues are the basis of much cognition. This is because the robot's self-perception can provide many basic and leading clues to the cognition of things, such as the robot's states, locations, tasks, environment, and the robot's own reference systems, which are all important clues to the cognition of things.

(2) The attention subsystem provides clues of sudden or significant changes in cognition clues, for example: significant changes in color, brightness, motion, sound, touch, magnetic field, temperature and other clues provided by the perception subsystem; the changes of the “desire” clues provided by language subsystem; the emergence of specific pattern clues, and so on.

The attention subsystem also provides continuous changing clues of continuous monitoring targets, and clues of changing relationships between monitoring targets. For example, the viewpoint position changes in the viewpoint migration and viewpoint tracking process, the change of the distance between the two points, etc. These clues are necessary for the visual servo actions of a robot.

(3) The understanding subsystem provides feature clues of modes of various things, taking the visual mode for example: clues like point position, parallax, color, brightness and so on; feature clues like point mode, line segment mode, endpoint mode, corner mode, curve mode, area mode, outline mode and so on; contour composition and movement clues, etc.

The so-called “understanding” firstly refers to the extraction of mode feature clues in the process of reconstructing the patterns of things; secondly, the meaning of understanding lies in that, the method to achieve feature clue extraction is the clue detector, while the connotation of the clue detector is exactly the logic and evidence of the validity of the clue.

(4) The memory subsystem provides memory clues of various durations. Instantaneous memory such as: viewpoint memory clues, view sequences, flash patterns, etc.; short-term memory such as various memory clues like location, object, task and various pronominal clues like “this”, “that”, “here”, “there”, etc.; long-term memory such as: specific situations, specific statements, sequences of actions, etc.

Memory is not only a method of clue preservation and recall, but also an important component of some clue detectors. For example, the brightness change detector needs to use the brightness clues from the same point in the previous moment; the displacement detector needs to use the previous and current point position clues; the track detector needs to use visual sequence clues.

(5) The language subsystem can provide guiding clues of the situation. For Example, the event concept clue of “downstairs” can facilitate relevant clues like “stairs”, “elevators”; the language subsystem can also provide the desire clues of initiative “look”, such as “look ahead”, “pay attention to the left”, etc.; the language subsystem can further provide confirmation clues of visual cognitive results, such as “This is . . . ”, “That is . . . ” etc.

The range of clues provided by the language subsystem is extremely wide. The clue categories related to language thinking such as thinking, motivation, emotion, and learning are all the subsystems of the language subsystem. The role of language clues in the cognition of various things is extremely important. The simple examples above can tell that the contextual guiding clues, viewpoint migration clues, learning guiding clues and other clues provided by language clues are all indispensable to the cognition of things.

(6) The regulation and control subsystem provides various regulation and control commands, such as: attention regulation commands, robot posture control commands, robot motion control commands, robot operation control commands, viewpoint migration commands, viewpoint migration's regulation and control commands, viewpoint tracking servo control commands and so on.

The regulation and control subsystem can also be subdivided into two levels: level of central regulation and control, and level of specific control. Central regulation and control subsystem integrates various significant change clues from the attention subsystem and issues regulation and control commands; the specific control subsystem further issues specific control commands based on the received regulation and control commands and realizes specific control.

Due to the huge variety and large number of clues, the clues must be collected selectively according to the needs of the cognition tasks, to select those important clues that are closely related to and have a significant effect on the cognition goal, while discard secondary clues, and to gradually optimize the selected clues during the process of design and using of the clue integration system.

### Embodiment 2: Basic Perceptual Clues of the World Reference System

The robot's perception of space needs to use a series of reference systems. The world reference system is the absolute reference system among the series of reference systems adopted by the robot, and generally does not change with the structure of the robot. The basic perceptual clues of the world reference system include: location, direction, orientation, etc.

In the world reference system, “location” is represented by the latitude and longitude data provided by the satellite positioning system, such as (East longitude 110, North latitude 45). The location data comes from sensors.

In the world reference system, the perceptual clues of basic directions include: up, down, east, west, south, and north. More subtle perception clues of direction include: north east (west) X, etc., where north refers to geographic north.

The “up” and “down” direction clues are based on the “gravity direction”, and the gravity direction clue comes from the gravity sensors.

“North” is the direction clue that can be obtained directly by the sensor, while the direction clues of east, west, south and “north by east (west) X” direction clues can be obtained only after further synthesis with related clues.

In the world reference system, the perceptual clues of the basic orientation include: horizontal and vertical, and more general orientation clues include: tilt. The orientation clues can be obtained by the vision of the robot, or by the collaboration of the orientation sensors and the robot's vision.

### Embodiment 3: Preliminary Integration of Robot “Standing Posture” Clue

The preliminary integration of clues refers to the filtration and collection of the source clues and target clues of the clue, excluding the clue-unit design.

The most commonly used postures of robots are “standing”, “sitting”, “lying”, etc. These perceptual clues are the basic clues of the robot's self-perception.

The robot's perception of its own posture relies not only on a series of relative reference system clues of the robot, but also on the positioning clues of these relative reference systems in the world reference system.

The gravity direction clue is provided by the gravity sensor, which is the most important clue of the world reference system. The angle clues (measured by sensors) formed by the gravity direction and some relative reference systems of the robot connect the relative reference systems with the world reference system, and become the positioning clues of the relative reference systems.

Since this embodiment uses an abstract robot, the above mentioned clues of the relative reference systems and the world reference system are also abstractly represented with the “robot posture benchmark clue set”, therefore the various postures of the robot can be obtained by adjusting and control of these posture benchmark clues.

FIG. 3 is a schematic diagram of the preliminary integration of the robot “Standing Posture” clue. The double dot line box in the figure separates the “Standing Posture” clue from its source and target clues.

The source clues of the “Standing Posture” clue is the “robot posture benchmark clue set”. Assuming that there are n pieces of the posture benchmark clues in the “robot posture benchmark clue set”, as shown in FIG. 3, therefore a specific posture of the robot must be a specific combination of the n posture benchmark clues.

When this specific combination meets the activation condition of the “Standing Posture” clue, the “Standing Posture” clue is activated into a valid clue. The “Standing Posture” clue detector just embodies such a specific valid clue combination.

The target clues of the “Standing Posture” clue are closely related to the development goals of the clue integration system. When the robot is in a “Standing Posture”, both the necessary and possible behaviors of the next step are all considered. In order to make the embodiment concise, only part of the target clues of the “Standing Posture” clue are listed in FIG. 3, and what is in brackets refers to the clue category.

Regarding connotation, the “Standing Posture” is a perceptual clue, the connotation of which is determined by “Standing Posture” clue detector, and unrelated to its name. The name, as the language representative of the connotation, “standing posture” exists in the language subsystem, apart from being used by system developers it is also a clue for the thinking and communication of robots.

“Where is the north?” clue is the thinking clue about the direction, which is in the language subsystem. It is included in the target clues because when the “Standing Posture” becomes a valid clue, perceiving direction is a possible behavior.

The “walking servo control” clue is a regulation and control clue. It is included in the target clues because when the “Standing Posture” becomes a valid clue, walking is a possible behavior.

Similarly, the “body posture regulation and control” clue is also a regulation and control clue. It is included in the target clues because when the “Standing Posture” becomes a valid clue, proceeding to regulate body posture is also a possible behavior.

The “motion perception regulation and control” clue is also a regulation and control clue. When there is a relative movement between the robot and the environment as the robot walks or regulates the posture, the relative movement caused by self-movement must be distinguished from the perceived movement clues, thereby ensuring the attention and cognition of external movement clues.

The “current posture memory” clue is a memory clue, usually a short-term perceptual memory.

The activation effect of the present clue (“Standing Posture”) to the above mentioned target clues are all “facilitation”. The so-called facilitation means that the target clues of the present clue will get easier to be activated into valid clues when the set output of the present clue is loaded to its target clues. But whether the target clues are activated into valid clues depends on whether the activation conditions of the target clues are met.

### Embodiment 4: Preliminary Integration of “(0) Pixel Point Pattern” Clue

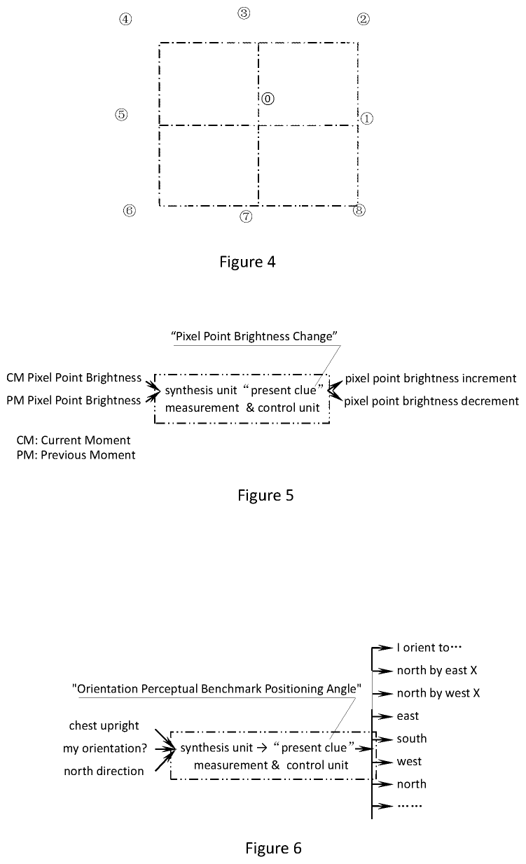

In the visual imaging reference system of a robot, select a pixel point randomly (referred as the present point). The present point and all its adjacent points compose a point pattern. The present point is located in the center of the pattern, and surrounded by its adjacent points. FIG. 4 illustrates the position of each point of the “(0) Pixel Point Pattern”, with the present point located in the center, eight adjacent points which are numbered from (1) to (8), form 8 directions.

The visual imaging reference system of a robot is similar to the reference system of the human retina. Vision clues of pixel points in the visual imaging reference system include the color components of red, green, blue, as well as the brightness and so on. The point pattern of a pixel point is the further expansion and synthesis of pixel visual clues, including the distribution of the color and brightness of each neighboring point. The point pattern of a pixel point belongs to the category of understanding clues.

The source clues of the “(0) Pixel Point Pattern” clue are as follows: the 9 Pixel points from point (0) to (8), each point has the red, green, blue and brightness clues, that make 36 cognitive clues in total.

The target clues of the “(0) Pixel Point Pattern” clue are as follows: the average contrast of the red, green, blue and brightness of the point pattern of pixel point (0); the direction contrast of the red, green, blue and brightness of the point pattern of pixel point (0) in its direction (1) to (8). There are 4 average contrast clues and 32 direction contrast clues that make 36 cognitive clues in total.

Said “average contrast” refers to the contrast between the parameter value of the present point and the average value of the homonymous parameter of all neighboring points, that is the difference between the parameter value of the present point and the average value of the homonymous parameter of the neighboring points. The clues of this type belong to the understanding category.

The so-called “direction contrast” means the contrast between the parameter value of the present point and the value of the homonymous parameter of neighboring point in a certain direction, that is to say, the difference between the parameter value of the present point and the value of the homonymous parameter of neighboring point in a certain direction. The clues of this type belong to the understanding category as well.

### Embodiment 5: The Design of the “Pixel Point Brightness Change” Clue-Unit

The brightness variation of a pixel point refers to the difference in brightness of the same pixel point between the current moment and the previous moment. Such a difference is the basic clue of the attention system, as the place where obvious changes in brightness often catch the attention of robots.

In the visual image reference system of a robot (equivalent to the reference system of human retina), select any one of the pixel points, one visual clue of the pixel point is “Pixel Point Brightness Change”. FIG. 5 illustrates the design schematic diagram of “Pixel Point Brightness Change” clue-unit, and this clue-unit is shown in the double-dot line box.

The present clue “Pixel Point Brightness Change” has two source clues. One is the perceptual clue “Current Moment pixel point brightness”, and the set output of this clue to the present clue is the pixel point brightness at current moment; the other is the memory clue “Previous Moment pixel point brightness”, and the set output of this clue to the present clue is the pixel point brightness at previous moment.

The present clue “Pixel Point Brightness Change” has two target clues. One is the “pixel point brightness increment” clue, and the other is the “pixel point brightness decrement” clue.

The synthesis rule of the synthesis unit of the “Pixel Point Brightness Change” clue-unit is: Δ=(Current Moment pixel point brightness)−(Previous Moment pixel point brightness). The activation condition of the present clue “Pixel Point Brightness Change” is: Δ≠0.

The measurement and control unit of the present clue-unit “Pixel Point Brightness Change” determines whether the activation condition of the present clue is met, if not, the present clue remains invalid.

If the activation condition is met, the activation state of the present clue is shifted from invalid to valid, the output unit is turned on, and the set output is loaded to all the target clues of the present clue according to the source-target relationships.

The set output of the “Pixel Point Brightness Change” clue to the “pixel point brightness increment” clue is: if Δ>0 output Δ, otherwise no output. The set output of the “Pixel Point Brightness Change” clue to the “pixel point brightness decrement” clue is: If Δ<0, output Δ, otherwise no output.

When the activation condition is no longer met, the measurement and control unit triggers the delay, in this embodiment the set delay is 2 milliseconds. When the set delay ends, the clue activation state is shifted to invalid, and the output unit is turned off.

### Embodiment 6: The Design of the “Orientation Perceptual Benchmark Positioning Angle” Clue-Unit

For a robot to perceive directions in the world reference system, such as determining “where is North?” or “What is my orientation?”, it needs to take a certain reference system of its own as the orientation reference system, and take a certain direction benchmark of this reference system as the orientation perceptual benchmark. In this embodiment, the chest reference system (left, upward, and forward reference system) of the robot is taken as the orientation reference system, and the “forward” direction of this chest reference system is taken as the orientation perceptual benchmark.

The connection between the orientation perceptual benchmark and the world reference system, in other words, the positioning of the orientation perceptual benchmark in the world reference system is realized by the angle ϕ between the orientation perceptual benchmark and the “north direction”. Therefore, the “north direction” is also referred to as the positioning benchmark of the orientation perceptual benchmark, and the angle ϕ is referred to as the orientation perceptual benchmark positioning angle.

When a robot determines the geographic direction, it usually needs to adjust its posture in order to make the orientation perceptual benchmark in a specific position. For example, to make the orientation reference system (the chest reference system) of the robot upright, that is, the “downward” direction is parallel to the direction of gravity, so that the robot's orientation perceptual benchmark is in the “horizontal position”.

To determine the geographic directions, a robot usually relies on specific task and environment clues to activate thinking decision clues like “determining my orientation”, in order to trigger relevant regulation and control, for example, to activate the clues of the “robot posture benchmark clue set”, to regulate the posture of the chest reference system, and then to trigger “Orientation Perceptual Benchmark Positioning Angle” clue.

FIG. 6 illustrates the design schematic diagram of the “Orientation Perceptual Benchmark Positioning Angle” clue-unit. There are three main source clues listed on the left of the figure: “my orientation?”, “chest upright”, and “north direction”.

The source clue, “my orientation?”, is a thinking decision clue of the language subsystem, which means that the robot wants to analyze and judge its orientation. This source clue's set output to be loaded to the present clue, “Orientation Perceptual Benchmark Positioning Angle”, is the activation state of this source clue.

The source clue, “chest upright”, is a self-perceptual clue, the connotation of this clue being activated into valid is that the chest reference system is in an upright state. This source clue's set output to be loaded to the present clue, “Orientation Perceptual Benchmark Positioning Angle”, is the activation state of this source clue.

The source clue, “north direction”, is a perceptual clue obtained by sensors, which provides a positioning benchmark of the orientation perceptual benchmark of the robot. This source clue's set output to be loaded to the present clue, “Orientation Perceptual Benchmark Positioning Angle”, is the activation state of this source clue.

The synthesis rule of the “Orientation Perceptual Benchmark Positioning Angle” clue-unit is taking the angle ϕ (obtained by sensors) as the synthesis result, and the angle ϕ is between the “orientation perceptual benchmark” and the “north direction”. The angle ϕ becomes positive when the “orientation perceptual benchmark” rotates counterclockwise against the positioning benchmark; and the angle ϕ becomes negative when the “orientation perceptual benchmark” rotates clockwise against the positioning benchmark; and 0<ϕ<180 means westward, −180<ϕ<0 means eastward.

The activation condition of the “Orientation Perceptual Benchmark Positioning Angle” clue is that all the three source clues which are “my orientation?”, “chest upright” and “north direction”, become valid clues, that is, the logical “with” of the activation states of these source clues is “true”.

To make it concise, FIG. 6 only lists part of the major target clues of the “Orientation Perceptual Benchmark Positioning Angle” clue, which are the direction perceptual clues such as “east”, “west”, “south”, “north”, “north-by-east X” and “north-by-west X” in the world reference system, as well as the language clue “I orient to”.

The “Orientation Perceptual Benchmark Positioning Angle” clue's set outputs to be loaded to the above mentioned target clues are as follows:

To the “north by west X” target clue: if 0<ϕ<180, output ϕ, otherwise no output.

To the “north by east X” target clue: if −180<ϕ<0, output ϕ, otherwise no output.

To the “east” target clue: if ϕ=−90, output the activation state of the present clue, otherwise no output.

To the “south” target clue: if ϕ=180, output the activation state of the present clue, otherwise no output.

To the “west” target clue: if ϕ=90, output the activation state of the present clue, otherwise no output.

To the “north” target clue: if ϕ=0, output the activation state of the present clue, otherwise no output.

To the “I orient to . . . ” target clue: output the activation state of the present clue.

### INDUSTRIAL APPLICABILITY

The present invention provides the basic structure and basic operation mechanism of the multi-category cognitive clue integration system, which can be used as the basic construction method and basic system of the brain-like artificial intelligent systems.

1. A basic configuration of a clue integration system, wherein the system comprises: clue, which is a core one among all elements that constitute a clue-unit; clue-unit, which is one of basic elements that constitute a clue-unit network; source-target relationship, which is a basic one of the elements that constitute the clue-unit network; clue-unit network, which is a basic structure and form of the clue integration system; measurement and control rules of a clue-unit, which are a constituent of clue detection driving mechanism; clue detection driving mechanism, which is basic operation mechanism of the clue integration system.

2. The basic configuration of the clue integration system according to claim 1, wherein characteristics of said clue are: each clue belongs to one clue-unit, and corresponds to the clue-unit one-to-one; each clue has a set activation condition; each clue has two activation states, which are valid or invalid.

3. The basic configuration of the clue integration system according to claim 1, wherein characteristics of said clue-unit are: each clue-unit has one clue and its set activation condition, and corresponds to the clue one-to-one; each clue-unit has an input unit, used to receive activation effects of its source clues; each clue-unit has a synthesis unit, used to make the activation effects of the source clues into a synthesized activation effect to be loaded to the present clue; each clue-unit has an output unit, used to load the activation effect of the present clue to target clues thereof; each clue-unit has a measurement and control unit, used to coordinate and control behaviors of various components of the clue-unit.

4. The basic configuration of the clue integration system according to claim 1, wherein characteristics of said source-target relationship are: each pair of source and target clues has a source-target relationship; each source-target relationship has a set output, used to set the source clue's activation effect to be loaded to the target clue; the source clue's activation effect to be loaded to the target clue is sent from the activation effect output unit of the source clue-unit, and received by the input unit of the corresponding target clue-unit.

5. The basic configuration of the clue integration system according to claim 1, wherein characteristics of said clue-unit network are:
the clue-unit network is formed by connecting the clue-units according to the source-target relationships between the clues.

6. The basic configuration of the clue integration system according to claim 1, wherein characteristics of said measurement and control rules of a clue-unit are: the sufficient and necessary condition for the present clue to be activated and maintained into a valid clue is that the synthesized activation effect to be loaded to the present clue meets the present clue's activation condition; if the present clue's activation condition is not met, the present clue remains invalid; if the present clue's activation condition is met, the present clue becomes a valid clue immediately, the output unit of the clue-unit is turned on, and the set outputs are loaded to all the target clues according to the source-target relationships; when the activation condition of the present clue is no longer met, a set delay is triggered immediately, and when the delay ends, the present clue returns to be invalid and the output unit is turned off.

7. The basic configuration of the clue integration system according to claim 1, wherein characteristics of said clue detection driving mechanism are: the measurement and control unit of each clue-unit runs autonomously according to the clue-unit measurement and control rules; all clue-units of the clue-unit network run in parallel according to the source-target relationships.
